(19) United States
(12) Patent Application Publication
(10) Pub. No.: US 2026/0249842 A1
(43) Pub. Date: Aug. 27, 2026

(54) EMERGENCY AVOIDANCE CONTROL SYSTEM, EMERGENCY AVOIDANCE CONTROL METHOD, AND COMPUTER-READABLE RECORDING MEDIUM

(71) Applicant: HL MANDO CORPORATION, Pyeongtaek-si (KR)

(72) Inventor: Junho SHIN, Pyeongtaek-si (KR)

(73) Assignee: HL MANDO CORPORATION, Pyeongtaek-si (KR)

(21) Appl. No.: 19/547,978

(22) Filed: Feb. 24, 2026

(30) Foreign Application Priority Data
Feb. 25, 2025 (KR) 10-2025-0024653
Jan. 16, 2026 (KR) 10-2026-0009132

(51) Int. Cl. B60W 30/09; B60W 10/18; B60W 10/20; B60W 30/095; B60W 50/14

(52) U.S. Cl. CPC B60W 30/09; B60W 10/18; B60W 10/20; B60W 30/0953; B60W 30/0956; B60W 50/14; B60W 2420/403; B60W 2420/408; B60W 2554/802; B60W 2554/803

(57) ABSTRACT

An emergency avoidance control system, an emergency avoidance control method, and a computer-readable recording medium are provided. More specifically, the present embodiment may provide an emergency avoidance control system, an emergency avoidance control method, and a computer-readable recording medium capable of not only actively performing emergency avoidance control without relying on a reaction speed of a driver, but also generating a plurality of avoidance paths and determining a path controllable with a minimum steering angle and a minimum steering speed among them as an avoidance path, thereby performing an efficient avoidance operation while maintaining driving stability, by determining a predicted collision time based on surrounding environment data obtained from a sensor and grading a collision risk based on the predicted collision time to enable a step-by-step response.

### CROSS-REFERENCE TO RELATED APPLICATIONS

This application claims the priorities of Korean Patent Application No. 10-2025-0024653 filed on February 25, 2025, and Korean Patent Application No. 10-2026-0009132 filed on January 16, 2026, which is hereby incorporated by reference for all purposes as if fully set forth herein.

### BACKGROUND

### Technical Field

The present embodiments relate to an emergency avoidance control system, an emergency avoidance control method, and a computer-readable recording medium, in which a vehicle automatically avoids a collision in an emergency situation occurring during driving.

### Description of the Related Art

An electric steering system of a vehicle comprises an Electric Power Steering (EPS) system that assists a manipulation force of a steering wheel using an electric machine such as a motor to provide convenience in driving manipulation, and a Steer By Wire (SBW) type steering system in which steering is performed using an electric machine such as a motor.

The electric power steering system has a structure connecting a steering wheel and a steering wheel via a mechanical link.

Since a steering input of a driver is physically transmitted, such an electric power steering system has limitations in responsiveness and control precision.

In particular, the electric power steering system relies on manual steering of the driver, and in this case, there is a problem that it is difficult to completely avoid a collision due to a reaction delay of the driver in an emergency situation.

In addition, the steer by wire steering system has a structure controlling steering only by electronic signals without a mechanical connection.

Such a steer by wire steering system has an advantage that high responsiveness and precise control are possible by electronically detecting the steering input of the driver and transmitting the steering input to a steering actuator.

### BRIEF SUMMARY

The inventors of the present disclosure have recognized that the steer by wire steering system is mainly limited to auxiliary functions in low-speed or normal driving situations such as parking assistance or lane keeping, and thus has limitations in performing an immediate and precise avoidance operation in an emergency situation occurring during high-speed driving.

That is, the conventional steer by wire steering system has difficulty in effectively preventing a collision in a braking distance shortage, a low friction road surface, and a high-speed driving situation, and has a problem that performance deteriorates or functions are limited under conditions such as bad weather, poor lane painting, and lane occlusion by a preceding vehicle due to heavy reliance on lane recognition performance.

Accordingly, various embodiments of the present disclosure provide an emergency avoidance control system configured to automatically perform a rapid and accurate avoidance operation in an emergency situation using an electric steering system.

The present embodiments may determine a predicted collision time based on surrounding environment data obtained from a sensor and grade a collision risk to enable a step-by-step response. Accordingly, the present embodiments may provide an emergency avoidance control system, an emergency avoidance control method, and a computer-readable recording medium capable of not only actively performing emergency avoidance control without relying on a reaction speed of a driver, but also generating a plurality of avoidance paths and determining a path controllable with a minimum steering angle and a minimum steering speed among them as an avoidance path, thereby performing an efficient avoidance operation while maintaining driving stability.

In one aspect, the present embodiments may provide an emergency avoidance control system comprising: a sensor configured to detect surroundings of a host vehicle to obtain surrounding environment data; and a controller configured to: determine a predicted collision time based on the surrounding environment data received from the sensor, determine a risk grade for a collision risk based on the predicted collision time, the risk grade comprising a low risk grade, a medium risk grade, and a high risk grade, and control a control module according to the risk grade.

In another aspect, the present embodiments may provide an emergency avoidance control method comprising: detecting surroundings of a host vehicle through a sensor to obtain surrounding environment data; analyzing a risk in which a situation determiner determines a predicted collision time based on the surrounding environment data and determines a risk grade for a collision risk based on the predicted collision time, the risk grade comprising a low risk grade, a

medium risk grade, and a high risk grade; generating a path in which a path setter generates a plurality of avoidance paths based on the surrounding environment data and determines among the plurality of avoidance paths, an avoidance path controllable with a minimum steering angle and a minimum steering speed; performing control in which, in response to the risk grade being determined to be the medium risk grade or the high risk grade, a path follower controls a control module to assist in following the determined avoidance path or to follow the determined avoidance path according to the risk grade; and outputting a warning in which a warning signal generator generates a warning signal notifying of an occurrence of an emergency situation and an emergency avoidance operation according to the determined risk grade and transmits the warning signal to the control module.

The present embodiments may determine the predicted collision time based on the surrounding environment data obtained from the sensor and grade the collision risk to enable the step-by-step response. Accordingly, the present embodiments may provide the emergency avoidance control system, the emergency avoidance control method, and the computer-readable recording medium capable of not only actively performing the emergency avoidance control without relying on the reaction speed of the driver, but also generating the plurality of avoidance paths and determining the path controllable with the minimum steering angle and the minimum steering speed among them as the avoidance path, thereby performing the efficient avoidance operation while maintaining the driving stability.

### BRIEF DESCRIPTION OF THE SEVERAL VIEWS OF THE DRAWINGS

FIG. 1 is a configuration diagram schematically illustrating a steer by wire type steering apparatus to which the present embodiments may be applied.

FIG. 2 is a block diagram illustrating an emergency avoidance control system according to the present embodiment.

FIG. 3 is a block diagram illustrating a sensor of the emergency avoidance control system according to the present embodiment.

FIG. 4 is a block diagram illustrating a controller of the emergency avoidance control system according to the present embodiment.

FIG. 5 is a block diagram illustrating a control module of the emergency avoidance control system according to the present embodiment.

FIG. 6 is a flowchart illustrating an emergency avoidance control method of the emergency avoidance control system according to the present embodiment.

FIG. 7 is a diagram for explaining a computer system of the emergency avoidance control system according to the present embodiments.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements, etc., but is used merely to distinguish the corresponding element from other elements.

If it is mentioned that a first element “is connected or coupled to”, “contacts or overlaps”, etc., a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc., each other via a fourth element. Here, the second element may be comprised in at least one of two or more elements that “are connected or coupled to”, “contact or overlap”, etc., each other.

If time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, if any dimensions, relative sizes, etc., are mentioned, it should be considered that numerical values for an elements or features, or corresponding information (e.g., level, range, etc.) comprise a tolerance or error range that may be caused by various factors (e.g., process factors, internal or external impact, noise, etc.) even if a relevant description is not specified. Further, the term “may” fully encompasses all the meanings of the term “can”.

The present disclosure describes driver assistance functionality comprising multi sensor perception using camera, radar, LiDAR, ultrasonic sensors, IMU, and GPS, together with object detection, time to collision risk classification, and coordinated vehicle control through steering, braking, and torque distribution. These functions, along with model predictive path generation, are commonly used in collision mitigation and autonomous driving systems. Accordingly, differentiation does not arise from the individual components but from their coordinated operation and governing decision logic.

The system selects an avoidance trajectory based on controllability rather than geometric clearance, specifically choosing the path requiring the minimum steering angle and steering rate to maintain dynamic stability. Control authority is then increased according to collision risk: warning only at low risk, steering assistance at medium risk, and full automatic intervention at high risk. The selected path is tracked through coordinated steering, differential braking, and drive force distribution while prioritizing stability and preventing oversteer or understeer, followed by a controlled return to lane or safe stop when appropriate.

The present disclosure therefore describes a dynamically feasible evasive steering framework in which path planning, driver and system control sharing, and coordinated actuator control are governed by predicted vehicle controllability rather than collision geometry alone. The approach selects a steering feasible trajectory and progressively transfers trajectory control from the driver to the system while cooperatively controlling multiple chassis actuators to carry out the maneuver.

The detailed description of the subject matter will be described with reference to the accompanying drawings.

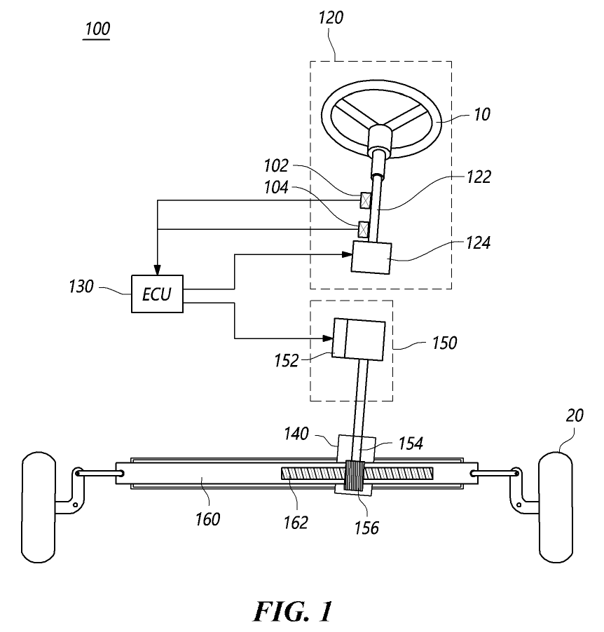

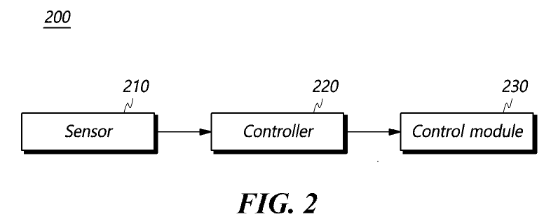

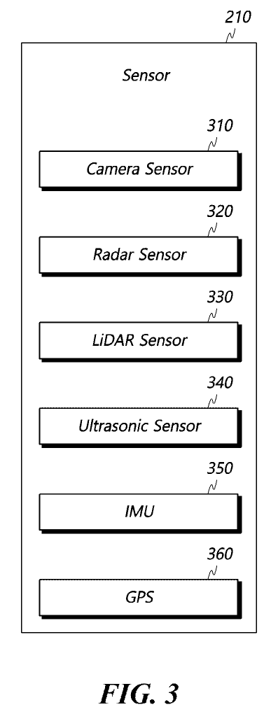

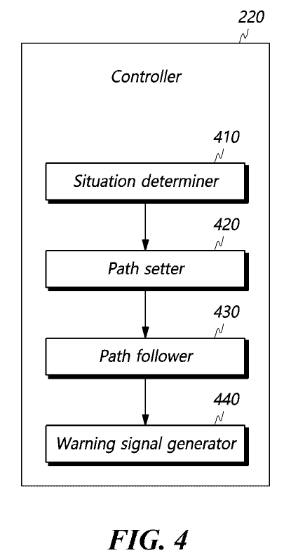

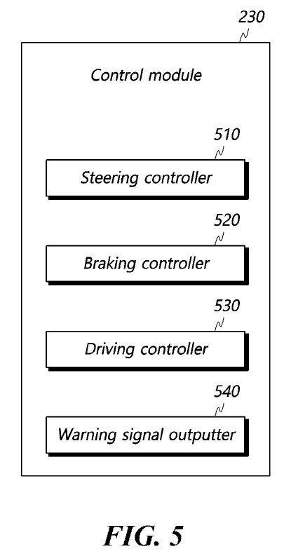

FIG. 1 is a configuration diagram schematically illustrating a steer by wire type steering apparatus to which the present embodiments may be applied. FIG. 2 is a block diagram illustrating an emergency avoidance control system according to the present embodiment. FIG. 3 is a block diagram illustrating a sensor of the emergency avoidance control system according to the present embodiment. FIG. 4 is a block diagram illustrating a controller of the emergency avoidance control system according to the present embodiment. FIG. 5 is a block diagram illustrating a control

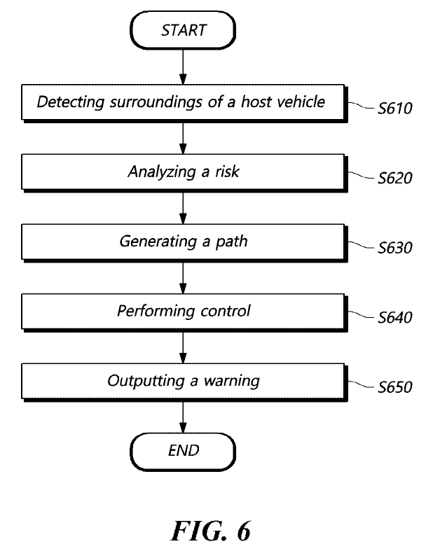

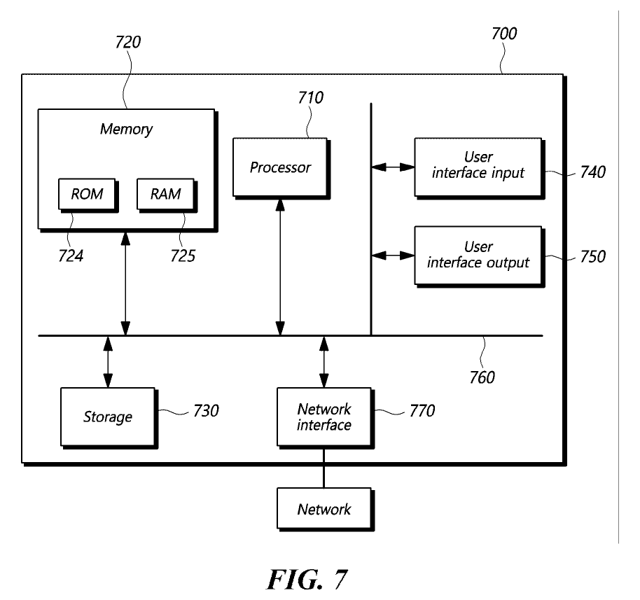

module of the emergency avoidance control system according to the present embodiment. FIG. 6 is a flowchart illustrating an emergency avoidance control method of the emergency avoidance control system according to the present embodiment. FIG. 7 is a diagram for explaining a computer system of the emergency avoidance control system according to the present embodiments.

An electric steering system comprises an Electric Power Steering (EPS) system that assists a manipulation force of a steering wheel using an electric machine such as a motor to provide convenience in driving manipulation, and a Steer by Wire (SbW) type steering system in which steering of an automobile is performed using an electric machine such as a motor. The emergency avoidance control system according to the present embodiment may be applied to the electric power steering system and the steer by wire steering system.

The electric power steering system has a structure connecting a steering wheel and a steering wheel via a mechanical link.

For example, in the electric power steering system, if a driver manipulates the steering wheel, a rotational force is transmitted to a pinion shaft through a steering shaft, and a pinion gear in a housing meshes with a rack gear to move a rack bar linearly, so that steering may be performed.

The steer by wire steering system has a structure that electronically detects a steering input of the driver and transmits the steering input to a steering actuator.

Referring to FIG. 1, a steer by wire steering system 100 is provided with a steering device 120 disposed close to a driver side and a steering actuator 150 disposed close to a wheel 20 side, a torque sensor 102 and an angle sensor 104 are coupled to one side of a steering shaft 122 connected to a steering wheel 10, and the torque sensor 102 and the angle sensor 104 detecting manipulation of the steering wheel 10 by the driver send electric signals to an electronic controller 130 to operate a reaction motor 124 and a drive motor 152.

The electronic controller 130 may control the reaction motor 124 and the drive motor 152 based on the electric signals transmitted from the torque sensor 102 and the angle sensor 104 and electric signals transmitted from various sensors mounted on other vehicles.

In the steer by wire steering system 100, if a rotational force of the drive motor 152 is transmitted to a pinion shaft 154, a pinion gear 156 in a housing 140 meshes with a rack gear 162 to linearly move a rack bar 160, so that steering may be performed.

In the present embodiment, various embodiments will be described in detail by taking, as an example, the steer by wire steering system 100 having a structure in which if the driver manipulates the steering wheel 10, the torque sensor 102 and the angle sensor 104 detecting this

send electric signals to the electronic controller 130 to operate the reaction motor 124 and the drive motor 152.

In the present embodiment, the steering actuator 150 has a dual power pack structure, and a first power pack and a second power pack may operate independently and simultaneously perform cooperative control through a communication unit.

The communication unit may exchange status information in real time through a first communication unit and a second communication unit performing CAN (Controller Area Network) communication, and the first communication unit and the second communication unit may use various vehicle communication protocols in addition to CAN communication.

The first power pack and the second power pack may share and provide a steering force according to a set torque distribution ratio, and if a failure occurs in any one power pack, it may be switched to a backup mode in which a normally operating power pack provides the entire steering assist force alone.

An emergency avoidance control system 200 according to the present embodiment may automatically perform an avoidance manipulation on the vehicle in an emergency situation such as a collision possibility or an occurrence of a road obstacle.

An “emergency situation” as used herein refers to a driving condition in which surrounding environment data indicates a collision risk that warrants at least driver assistance or automatic control of a vehicle. The emergency situation is not limited to a particular object type, roadway configuration, or threshold value, and may comprise conditions involving obstacles, surrounding vehicles, pedestrians, road hazards, or changes in vehicle dynamics. The determination of the emergency situation may be made based on predicted collision time, relative distance, relative speed, available avoidance space, vehicle behavior, or a combination thereof, and may correspond to a risk level at which warning, assisted control, or automatic avoidance control is performed.

Referring to FIG. 2, the emergency avoidance control system 200 may comprise a sensor 210 detecting surroundings of a host vehicle to obtain surrounding environment data, and a controller 220 determining a predicted collision time based on the surrounding environment data received from the sensor 210, determining a risk grade for a collision risk based on the predicted collision time, and controlling a control module 230 according to the risk grade.

Such an emergency avoidance control system 200 may be connected to the steer by wire steering system 100, a driving system, a braking system, and the like of the vehicle through an internal communication network of the vehicle to perform integrated vehicle control.

Referring to FIG. 3, the sensor 210 may comprise at least one of a Camera Sensor 310 photographing the surroundings of the host vehicle to obtain image information, a Radar Sensor 320 detecting an object around the host vehicle, a LiDAR (Light Detection and Ranging) Sensor 330 obtaining 3D spatial information around the host vehicle, an Ultrasonic Sensor 340 measuring a distance between the host vehicle and a surrounding object, an IMU (Inertial Measurement Unit) 350 measuring an acceleration and an angular velocity of the host vehicle, or a GPS (Global Positioning System) 360 obtaining a current position of the host vehicle.

The camera sensor 310 is installed at each of the front, left, right, and rear of the vehicle to photograph the surroundings of the vehicle, and may obtain omnidirectional image information.

The camera sensor 310 may detect road conditions and surrounding objects in front of the vehicle to recognize various types of road conditions, obstacles, and surrounding vehicles.

The radar sensor 320 may detect an object within a maximum range of 200 m using millimeter waves in a band of about 77 GHz, and may also obtain speed and direction information of the object.

The radar sensor 320 may provide data for determining a TTC (Time to Collision) between the host vehicle and the object.

The LiDAR sensor 330 may generate 3D point cloud data within a maximum range of 100 m in 360-degree omnidirectionality using a laser with a wavelength of about 905 nm.

The LiDAR sensor 330 may provide precise 3D spatial information using laser pulses, and may identify exact positions and movements of surrounding objects in centimeters.

The ultrasonic sensor 340 may measure a distance to an object within a maximum range of 5 m using ultrasonic waves in a band of about 40 kHz.

The ultrasonic sensor 340 may perform short-range object detection in a low-speed driving situation or a parking situation, and may detect a pedestrian or an obstacle in a blind spot.

The IMU 350 may measure the acceleration and the angular velocity of the vehicle to detect a dynamic behavior of the vehicle in real time, and may monitor posture stability of the vehicle during a sudden avoidance operation.

The GPS 360 may obtain the current position of the vehicle, and may provide information such as curvature of a road, lane information, and a speed limit by combining with HD map data.

Accordingly, the sensor 210 may acquire driving information of surrounding vehicles in real time, and may update the driving information of the surrounding vehicles every preset time and transmit the driving information to the controller 220.

At this time, the controller 220 may analyze the surrounding environment data transmitted from the sensor 210 in real time to generate surrounding environment information comprising relative longitudinal positions, relative lateral positions, relative longitudinal speeds, relative lateral speeds, and turn signal lighting states of surrounding objects with respect to the host vehicle.

In addition, the controller 220 may analyze the surrounding environment data transmitted from the sensor 210 in real time to continuously monitor movements of surrounding vehicles, and may check an avoidable space in real time.

Referring to FIG. 4, the controller 220 may comprise a situation determiner 410, a path setter 420, a path follower 430, and a warning signal generator 440. The situation determiner 410 may determine the predicted collision time based on the surrounding environment data received from the sensor 210, and determine the risk grade for the collision risk based on the predicted collision time. The path setter 420 may generate a plurality of avoidance paths based on the surrounding environment data received from the sensor 210, and determine a minimum steering path among the plurality of avoidance paths as the avoidance path. If the risk grade is determined to be a risk grade of an intermediate level or higher, the path follower 430 may control the control module 230 to assist in following the determined avoidance path or to follow the determined avoidance path according to the risk grade. The warning signal generator 440 may generate a warning signal notifying of an occurrence of an emergency situation and an emergency avoidance operation according to the determined risk grade and transmit the warning signal to the control module 230.

Specifically, the situation determiner 410 may determine the predicted collision time based on the surrounding environment data received from the sensor 210, and determine the risk grade for the collision risk based on the predicted collision time.

The situation determiner 410 may analyze a relative distance and a relative speed with respect to the object to classify the collision risk into three levels of a low risk grade, a medium risk grade, and a high risk grade based on a time remaining until collision, and determine the predicted collision time to determine the risk grade for the collision risk.

That is, the situation determiner 410 may analyze the relative distance and the relative speed with respect to the object to determine the TTC (Time to Collision), and classify the collision

risk into three levels of the low risk grade, the medium risk grade, and the high risk grade based on the time remaining until collision.

At this time, the emergency avoidance control system 200 may provide only the warning signal in the low risk grade, perform control assisting manipulation of the driver in the medium risk grade, and perform vehicle control in the high risk grade.

For example, if the host vehicle is driving at 60 km/h and a stopped object is detected at a point 100 meters ahead, the situation determiner 410 may determine the risk grade as follows.

The situation determiner 410 may classify as the low risk grade if the TTC is 6 seconds or more, classify as the medium risk grade if the TTC is 3 seconds or more and less than 6 seconds, and classify as the high risk grade if the TTC is less than 3 seconds.

If the distance to the front object is 100 meters and the speed of the host vehicle is 60 km/h, the TTC may be determined to be about 6 seconds, and in this case, the situation determiner 410 may classify as the low risk grade.

In the low risk grade, the warning signal generator 440 may generate the warning signal and transmit the warning signal to the control module 230 to output the warning signal.

If the distance to the front object is 50 meters and the speed of the host vehicle is 60 km/h, the TTC may be determined to be about 3 seconds, and in this case, the situation determiner 410 may classify as the medium risk grade.

In the medium risk grade, the path follower 430 may control the control module 230 to assist in following the determined avoidance path in order to perform control assisting the manipulation of the driver.

If the distance to the front object is 30 meters and the speed of the host vehicle is 60 km/h, the TTC may be determined to be about 1.8 seconds, and in this case, the situation determiner 410 may classify as the high risk grade.

In the high risk grade, the path follower 430 may control the control module 230 to follow the determined avoidance path in order to perform vehicle control.

The situation determiner 410 may apply the same principle even if there is a relative speed. For example, if a preceding vehicle is driving at 40 km/h, the relative speed becomes 20 km/h, which may be reflected in the TTC determination.

Subsequently, the path setter 420 may generate the plurality of avoidance paths based on the surrounding environment data received from the sensor 210, and determine a path controlled with a minimum steering angle and a minimum steering speed among the plurality of avoidance paths as the avoidance path.

The path setter 420 may generate an optimal path considering the dynamic behavior of the vehicle and environmental conditions, and may simulate all possible paths based on a vehicle dynamics model and the surrounding environment data.

The path setter 420 may select a path using a minimum steering angle while avoiding an object with a collision possibility, and may plan the path so that the vehicle prevents an abnormal behavior such as oversteer or understeer in cooperation with an Electronic Stability Control (ESC).

The path setter 420 may determine the optimal path considering dynamic characteristics of the vehicle and the surrounding environment using a model predictive control algorithm.

If the risk grade is determined to be the risk grade of the intermediate level or higher, the path follower 430 may control the control module 230 to assist in following the determined avoidance path or to follow the determined avoidance path according to the risk grade.

The path follower 430 may control to return to an original lane after the avoidance operation, and may safely stop the vehicle if the return is difficult.

The warning signal generator 440 may generate the warning signal notifying of the occurrence of the emergency situation and the emergency avoidance operation according to the determined risk grade and transmit the warning signal to the control module 230.

Referring to FIG. 5, the control module 230 may comprise a steering controller 510, a braking controller 520, a driving controller 530, and a warning signal outputter 540.

The steering controller 510 may control the steering actuator to follow the avoidance path. The braking controller 520 may apply a differential braking force to each wheel to assist in following the avoidance path. The driving controller 530 may distribute a driving force to each wheel to assist in following the avoidance path. The warning signal outputter 540 may output the warning signal through at least one of vibration of the steering wheel 10, a change in steering resistance, a visual warning signal, or an auditory warning signal.

Specifically, if the risk grade is determined to be the risk grade of the intermediate level or higher, the steering controller 510 may control the steering actuator to assist in following the selected avoidance path according to the risk grade or control the steering actuator to follow the selected avoidance path.

In the medium risk grade, the steering controller 510 may operate in a manner of assisting the steering input of the driver.

For example, in a situation where the host vehicle is driving at 60 km/h, an object is detected at a point 50 meters ahead, and the TTC is determined to be about 3 seconds, if the path

setter 420 generates an avoidance path to a left lane, the steering controller 510 may provide an additional steering assist force if the driver manipulates the steering wheel 10 to the left.

At this time, the steering controller 510 may apply an assist torque to the drive motor 152 of the steer by wire steering system 100 in the same direction as a steering torque of the driver to support a quick and accurate avoidance operation.

In the high risk grade, the steering controller 510 may operate in an autonomous driving control manner.

For example, if the host vehicle is driving at a high speed of 100 km/h, a suddenly stopped vehicle is detected at a point 30 meters ahead, and the TTC is determined to be 1.2 seconds, if the path setter 420 generates an avoidance path to a right lane, the steering controller 510 may automatically follow the avoidance path planned by the path setter 420 regardless of the steering input of the driver.

That is, if an avoidance path requiring a steering angle of 12 degrees to the right is generated, the steering controller 510 may directly control the drive motor 152 to reach a target steering angle.

The steering controller 510 may limit a steering speed so that a lateral acceleration of the vehicle does not exceed a preset value in a process of following the avoidance path, and may continuously correct a steering control amount based on real-time vehicle posture information received from the IMU 350.

In addition, the steering controller 510 may perform steering control in an opposite direction to return the vehicle to the original lane after completion of the avoidance operation, and at this time, may perform a stable return operation considering ride comfort of passengers by gradually reducing a rate of change of the steering angle.

The braking controller 520 may perform differential braking control generating a yaw moment using a difference in braking force between left and right wheels.

For example, in a situation where a front object is detected while the host vehicle is driving and needs to be avoided, the braking controller 520 may apply a stronger braking force to any one wheel to generate the yaw moment, thereby controlling to follow closer to a target avoidance path.

In addition, if an oversteer or understeer phenomenon of the vehicle occurs in a process of following a sharp right turn avoidance path, the braking controller 520 may selectively apply the braking force to each wheel to generate the yaw moment, thereby controlling to follow closer to the target avoidance path.

Through this, the braking controller 520 may support the vehicle to safely avoid the object without deviating from the planned avoidance path.

Here, the braking controller 520 may interwork with the Electronic Stability Control (ESC) to assist in following the avoidance path and secure stability of the vehicle.

That is, the braking controller 520 may perform the differential braking control while maintaining an ABS (Anti-lock Brake System) function in conjunction with the Electronic Stability Control (ESC), and may adjust the braking force in real time so that a slip ratio of each wheel does not exceed a preset value.

In addition, the braking controller 520 may equally adjust the braking force of all wheels after following of the avoidance path is completed to stably return the vehicle to an original driving state.

The driving controller 530 may reduce an avoidance path following error through distribution of the driving force of each wheel.

For example, if the oversteer or understeer phenomenon occurs in the process of the host vehicle following the avoidance path, the driving controller 530 may apply a larger driving force to any one wheel to generate the yaw moment, thereby controlling to follow closer to the target avoidance path.

Here, in the case of a vehicle to which an in-wheel motor is applied, the driving controller 530 may individually and precisely control torque of each wheel, and in a vehicle having a general drive shaft, the driving controller 530 may improve accuracy of following the avoidance path through torque distribution between the left and right wheels.

The warning signal outputter 540 may output the warning signal through at least one of the vibration of the steering wheel 10, the change in steering resistance, the visual warning signal, or the auditory warning signal.

The warning signal outputter 540 may warn of a risk through the vibration of the steering wheel 10 or the change in steering resistance if the emergency situation occurs, and may provide visual and auditory notifications to the driver through a HUD (Head-Up Display) or an audio warning.

The emergency avoidance control system 200 of the present embodiment may be integrated with an autonomous driving system, and the system may automatically intervene if the emergency situation occurs during autonomous driving.

In addition, the emergency avoidance control system 200 may be provided with continuous learning data and algorithm updates based on a cloud through an OTA (Over-The-Air) update, and may reflect various local road conditions and accident data.

In addition, the emergency avoidance control system 200 may communicate with surrounding vehicles and infrastructure through V2X (Vehicle-to-Everything) communication to improve collision risk prediction accuracy, and may detect an emergency vehicle such as an ambulance to apply an avoidance operation.

The emergency avoidance control method for avoiding the collision of the vehicle according to the present embodiment may comprise detecting the surroundings of the vehicle, analyzing a risk level for the collision risk, generating the avoidance path, controlling the control module based on the avoidance path, and outputting the warning signal.

The emergency avoidance control method for avoiding the collision of the vehicle according to the present embodiment will be described in detail with reference to FIG. 6 as follows.

As an example, the emergency avoidance control method according to the present embodiment may comprise detecting surroundings of a host vehicle to obtain surrounding environment data (S610).

The emergency avoidance control system of the present embodiments may detect the surroundings of the vehicle through the sensor 210 to obtain the surrounding environment data.

At this time, the sensor 210 may detect the surroundings of the host vehicle through the camera sensor 310, the radar sensor 320, the LiDAR sensor 330, the ultrasonic sensor 340, the IMU 350, and the GPS 360.

The emergency avoidance control system of the present embodiments may detect an object around the host vehicle in real time through the camera sensor 310, the radar sensor 320, the LiDAR sensor 330, and the ultrasonic sensor 340, monitor a dynamic state of the vehicle through the IMU, and obtain road environment information by utilizing the GPS and a high-precision map.

As another example, the emergency avoidance control method according to the present embodiment may comprise analyzing a risk in which a predicted collision time is determined based on the surrounding environment data, and a risk grade for a collision risk is determined based on the predicted collision time (S620).

The emergency avoidance control system of the present embodiments may determine the predicted collision time based on the surrounding environment data to determine the risk grade for the collision risk.

The emergency avoidance control system of the present embodiments may analyze a relative distance and a relative speed with respect to the object through the situation determiner 410 to determine a TTC (Time to Collision), and classify the collision risk into three levels of a low risk grade, a medium risk grade, and a high risk grade based on a time remaining until collision.

The emergency avoidance control system of the present embodiments may identify a type and characteristics of the object by utilizing a deep learning-based object recognition algorithm, and determine the TTC between the host vehicle and the object.

In addition, the emergency avoidance control system of the present embodiments may analyze the surrounding environment data transmitted from the sensor 210 in real time to continuously monitor movements of surrounding vehicles, and check an avoidable space in real time.

As another example, the emergency avoidance control method according to the present embodiment may comprise generating a path in which a plurality of avoidance paths are generated based on the surrounding environment data, and a minimum steering path among the plurality of avoidance paths is determined as an avoidance path (S630).

The emergency avoidance control system of the present embodiments may generate the plurality of avoidance paths based on the surrounding environment data through the path setter 420, and determine a path controlled with a minimum steering angle and a minimum steering speed among the plurality of avoidance paths as the avoidance path.

The emergency avoidance control system of the present embodiments may generate an optimal path considering a dynamic behavior of the vehicle and environmental conditions, and simulate all possible paths based on a vehicle dynamics model and road data.

The path setter 420 of the emergency avoidance control system of the present embodiments may select a path using a minimum steering angle while avoiding the object, and plan the path so that the vehicle prevents an abnormal behavior such as oversteer or understeer in cooperation with an Electronic Stability Control (ESC).

The emergency avoidance control system of the present embodiments may check a width of a driving lane and whether a lane change is possible, and track speed and direction which are movements of surrounding vehicles to select a safe avoidance path.

As another example, the emergency avoidance control method according to the present embodiment may comprise performing control in which, if the risk grade is determined to be a risk grade of an intermediate level or higher, the control module is controlled to assist in following

the determined avoidance path or to follow the determined avoidance path according to the risk grade (S640).

The emergency avoidance control system of the present embodiments may output only a warning signal if the risk grade is the low risk grade. The emergency avoidance control system of the present embodiments may control the control module to assist in following the determined avoidance path if the risk grade is the medium risk grade. The emergency avoidance control system of the present embodiments may control the control module to follow the determined avoidance path if the risk grade is the high risk grade.

That is, the emergency avoidance control system of the present embodiments may adjust a system intervention level step by step according to the risk grade, provide the warning signal in the low risk grade, assist manipulation of the driver in the medium risk grade, and automatically intervene in vehicle control in the high risk grade.

Here, the emergency avoidance control system of the present embodiments may comprise controlling the steering actuator so that the steering controller 510 follows the avoidance path, performing differential braking control in which the braking controller 520 generates a yaw moment using a difference in braking force between left and right wheels, and reducing an avoidance path following error through distribution of a driving force of each wheel by the driving controller 530.

In controlling the steering actuator so that the steering controller 510 follows the avoidance path, the emergency avoidance control system of the present embodiments may compare a target avoidance path generated by the path setter 420 with a current position and direction of the host vehicle to determine a necessary steering angle.

The above-described steering controller 510 may transmit a precise torque command to the drive motor 152 of the steer by wire steering system 100 by utilizing a PID control algorithm or an LQR control algorithm.

For example, if a steering angle of 15 degrees to the left is required, the steering controller 510 may control a rotation speed and torque of the drive motor 152 in real time to reach a target angle, and at the same time, feed back yaw rate and lateral acceleration information of the vehicle received from the IMU 350 to improve accuracy of steering control.

In the differential braking control in which the braking controller 520 generates the yaw moment using the difference in braking force between the left and right wheels, the emergency avoidance control system of the present embodiments may apply a differential braking force to each wheel to assist in following the avoidance path.

The above-described braking controller 520 may interwork with the Electronic Stability Control (ESC) to detect an understeer or oversteer phenomenon of the vehicle, and selectively apply a braking force to a specific wheel if necessary.

For example, if understeer occurs during right turn avoidance, the braking force may be applied to a left wheel to generate the yaw moment, and braking pressure may be adjusted in real time while maintaining an ABS function so that a slip ratio of each wheel does not exceed a preset value.

In reducing the avoidance path following error through the distribution of the driving force of each wheel by the driving controller 530, the emergency avoidance control system of the present embodiments may adjust torque distribution between the left and right wheels by utilizing torque vectoring technology.

The above-described driving controller 530 may determine a deviation between an actual traveling direction of the current vehicle and the target avoidance path, and apply differential torque to the left and right wheels to correct the deviation.

In the case of a vehicle to which an in-wheel motor is applied, precise torque distribution may be performed by individually controlling torque of each wheel, and in a vehicle having a general drive shaft, accuracy of following the avoidance path may be improved by generating a torque difference between the left and right wheels through a limited slip differential or a torque distribution clutch to execute fine path correction.

The emergency avoidance control system of the present embodiments may perform control to return to an original lane after completion of the avoidance operation, and execute control to safely stop the vehicle if the return is difficult.

As another example, the emergency avoidance control method according to the present embodiment may comprise outputting a warning in which a warning signal notifying of an occurrence of an emergency situation and an emergency avoidance operation is generated based on the risk grade and transmitted to the control module (S650).

The emergency avoidance control system of the present embodiments may generate the warning signal notifying of the occurrence of the emergency situation and the emergency avoidance operation according to the risk grade and transmit the warning signal to the control module.

The emergency avoidance control system of the present embodiments may warn of a risk through vibration of the steering wheel 10 or a change in steering resistance if the emergency

situation occurs, and provide visual and auditory notifications to the driver through a HUD (Head-Up Display) or audio.

The emergency avoidance control method of the present embodiment enables integrated operation with an autonomous driving system, and may comprise a method in which the system automatically intervenes if the emergency situation occurs during autonomous driving.

Referring to FIG. 7, the above-described present embodiments may be implemented in a computer system, for example, as a computer-readable recording medium.

As shown in the figure, a computer system 700 of the emergency avoidance control system 200 may comprise at least one or more elements among one or more processors 710, a memory 720, a storage 730, a user interface input 740 or a user interface output 750, and they may communicate with each other via a bus 760.

In addition, the computer system 700 may also comprise a network interface 770 for accessing a network.

The processor 710 may be a CPU or a semiconductor device that executes processing instructions stored in the memory 720 and/or the storage 730.

The memory 720 and the storage 730 may comprise various types of volatile/non-volatile storage media.

For example, the memory may comprise a ROM 724 and a RAM 725.

Accordingly, the present embodiments may be implemented as a computer-implemented method or a non-volatile computer recording medium storing computer-executable instructions.

The instructions, when executed by a processor, may perform a method according to at least one embodiment of the present embodiments.

The present embodiments determine the predicted collision time based on the surrounding environment data obtained from the sensor and grade the collision risk to enable the step-by-step response, thereby having an effect of not only actively performing the emergency avoidance control without relying on a reaction speed of the driver, but also generating the plurality of avoidance paths and determining the path controllable with the minimum steering angle and the minimum steering speed among them as the avoidance path, thereby performing the efficient avoidance operation while maintaining driving stability.

The above description has been presented to enable any person skilled in the art to make and use the technical idea of the present disclosure, and has been provided in the context of a particular application and its requirements. Various modifications, additions and substitutions to the

described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to comprise all possible embodiments along with the full scope of equivalents to which such claims are entitled. Accordingly, the claims are not limited by the disclosure.

1. An emergency avoidance control system comprising:
a sensor configured to detect surroundings of a host vehicle to obtain surrounding environment data; and
a controller configured to:
determine a predicted collision time based on the surrounding environment data received from the sensor,
determine a risk grade for a collision risk based on the predicted collision time, the risk grade comprising a low risk grade, a medium risk grade, and a high risk grade, and
control a control module according to the risk grade.

2. The emergency avoidance control system of claim 1,
wherein the controller comprises:
a situation determiner configured to determine the predicted collision time based on the surrounding environment data received from the sensor, and to determine the risk grade for the collision risk based on the predicted collision time;
a path setter configured to generate a plurality of avoidance paths based on the surrounding environment data received from the sensor, and determine, among the plurality of avoidance paths, an avoidance path controllable with a minimum steering angle and a minimum steering speed; and
a path follower configured to control the control module to assist in following the determined avoidance path or to follow the determined avoidance path according to the risk grade in response to the risk grade being determined to be the medium risk grade or the high risk grade.

3. The emergency avoidance control system of claim 2,
wherein the controller further comprises a warning signal generator configured to generate a warning signal notifying of an occurrence of an emergency situation and an emergency avoidance operation according to the risk grade and transmit the warning signal to the control module.

4. The emergency avoidance control system of claim 3,
wherein the situation determiner configured to analyze a relative distance and a relative speed with respect to an object to classify the collision risk into three levels of a low risk grade, a medium risk grade, and a high risk grade based on a time remaining until collision, and determine the risk grade for the collision risk based on the predicted collision time.

5. The emergency avoidance control system of claim 4,
wherein the warning signal generator configured to generate the warning signal and transmit the warning signal to the control module in response to the risk grade being the low risk grade.

6. The emergency avoidance control system of claim 4,
wherein the path follower is configured to control the control module to assist in following the determined avoidance path in response to the risk grade being the medium risk grade.

7. The emergency avoidance control system of claim 4,
wherein the path follower is configured to control the control module to follow the determined avoidance path in response to the risk grade being the high risk grade.

8. The emergency avoidance control system of claim 2,
wherein the avoidance path is selected by comparing the minimum steering angle and the minimum steering speed of each of the plurality of avoidance paths.

9. The emergency avoidance control system of claim 1,
wherein the control module comprises:
a steering controller configured to control a steering actuator to follow an avoidance path;
a braking controller configured to apply a differential braking force to each wheel to assist in following the avoidance path; and
a driving controller configured to distribute a driving force to each wheel to assist in following the avoidance path.

10. The emergency avoidance control system of claim 9,
wherein in response to the risk grade being determined to be the medium risk grade or the high risk grade, the steering controller controls the steering actuator to assist in following a selected avoidance path according to the risk grade or controls the steering actuator to follow the selected avoidance path.

11. The emergency avoidance control system of claim 9,
wherein the braking controller is configured to perform differential braking control generating a yaw moment using a difference in braking force between wheels of the host vehicle located on opposite lateral sides.

12. The emergency avoidance control system of claim 9,
wherein the driving controller is configured to reduce an avoidance path following error through distribution of the driving force of each wheel of the host vehicle.

13. The emergency avoidance control system of claim 9,
wherein the control module further comprises a warning signal outputter configured to output a warning signal based on at least one of vibration of a steering wheel, a change in steering resistance, a visual warning signal, or an auditory warning signal.

14. The emergency avoidance control system of claim 1,
wherein the sensor comprises at least one of:
a camera sensor photographing the surroundings of the host vehicle to obtain image information;
a radar sensor detecting an object around the host vehicle;
a LiDAR sensor obtaining 3D spatial information around the host vehicle;
an ultrasonic sensor measuring a distance between the host vehicle and a surrounding object;
an inertial measurement unit measuring an acceleration and an angular velocity of the host vehicle; or
a GPS obtaining a current position of the host vehicle.

15. An emergency avoidance control method comprising:
detecting surroundings of a host vehicle through a sensor to obtain surrounding environment data;
analyzing a risk in which a situation determiner determines a predicted collision time based on the surrounding environment data and determines a risk grade for a collision risk based on the predicted collision time, the risk grade comprising a low risk grade, a medium risk grade, and a high risk grade;
generating a path in which a path setter generates a plurality of avoidance paths based on the surrounding environment data and determines, among the plurality of avoidance paths, an avoidance path controllable with a minimum steering angle and a minimum steering speed;
performing control in which, in response to the risk grade being determined to be the medium risk grade or the high risk grade, a path follower controls a control module to assist in following the determined avoidance path or to follow the determined avoidance path according to the risk grade; and
outputting a warning in which a warning signal generator generates a warning signal notifying of an occurrence of an emergency situation and an emergency avoidance operation according to the determined risk grade and transmits the warning signal to the control module.

16. The emergency avoidance control method of claim 15,
wherein the situation determiner analyzes a relative distance and a relative speed with respect to an object to classify the collision risk into three levels of the low risk grade, the medium risk grade, and the high risk grade based on a time remaining until collision, and determines the risk grade for the collision risk based on the predicted collision time.

17. The emergency avoidance control method of claim 15,
wherein the path setter generates the plurality of avoidance paths based on the surrounding environment data, and determines a path controlled with the minimum steering angle and the minimum steering speed among the plurality of avoidance paths as the avoidance path.

18. The emergency avoidance control method of claim 16,
wherein the path follower outputs only the warning signal in the low risk grade, controls the control module to assist in following the determined avoidance path in the medium risk grade, and controls the control module to follow the determined avoidance path in the high risk grade.

19. The emergency avoidance control method of claim 15,
wherein the performing of the control comprises:
controlling a steering actuator to follow the avoidance path through a steering controller;
performing differential braking control generating a yaw moment using a difference in braking force between left and right wheels through a braking controller; and
reducing an avoidance path following error through distribution of a driving force of each wheel through a driving controller.

20. A computer-readable recording medium storing a computer program, wherein the computer program, when executed by one or more processors, causes the one or more processors to perform steps, the steps comprising:
detecting surroundings of a host vehicle through a sensor to obtain surrounding environment data;
analyzing a risk in which a situation determiner determines a predicted collision time based on the surrounding environment data and determines a risk grade for a collision risk based on the predicted collision time;
generating a path in which a path setter generates a plurality of avoidance paths based on the surrounding environment data and determines, among the plurality of avoidance paths, an avoidance path controllable with a minimum steering angle and a minimum steering speed;
performing control in which, in response to the risk grade being determined to be a risk grade of an intermediate level or higher, a path follower controls a control module to assist in following the determined avoidance path or to follow the determined avoidance path according to the risk grade; and
outputting a warning in which a warning signal generator generates a warning signal notifying of an occurrence of an emergency situation and an emergency avoidance operation according to the determined risk grade and transmits the warning signal to the control module.
